(19) United States
(12) Patent Application Publication
(10) Pub. No.: US 2011/0132885 A1
(43) Pub. Date: Jun. 9, 2011

(54) LASER MACHINING AND SCRIBING SYSTEMS AND METHODS

(75) Inventors: Jeffrey P. Sercel, Hollis, NH (US); Marco Mendes, Manchester, NH (US); Randal R. Hill, Nashua, NH (US); Norm Bergeron, Hudson, NH (US); Jeremy Hsu, Jubei City (TW); Lawrence Liu, Jubei City (TW)

(73) Assignee: J.P. Sercel Associates, Inc., Manchester, NH (US)

(21) Appl. No.: 12/962,050

(22) Filed: Dec. 7, 2010

Related U.S. Application Data
(60) Provisional application No. 61/267,190, filed on Dec. 7, 2009.

(51) Int. Cl. B23K 26/00

(52) U.S. Cl. 219/121.72; 219/121.67

(57) ABSTRACT

A laser machining system may include an opposite side camera to provide workpiece alignment from an opposite side of the system (i.e., the side opposite the laser machining process). The opposite side camera may be used with an air bearing positioning stage, and a portion of the stage and/or the opposite side camera may be moved to allow the opposite side camera to image a feature on the workpiece to be aligned. The opposite side alignment may be used with back side scribing and/or dual side scribing of a workpiece with alignment from one or both sides of the workpiece. Laser machining systems and methods may also be used to provide quasi-stealth scribing and multi-beam scribing.

### CROSS-REFERENCE TO RELATED APPLICATION

The present application claims the benefit of U.S. Provisional Patent Application Ser. No. 61/267,190 filed Dec. 7, 2009, which is incorporated herein by reference.

### TECHNICAL FIELD

The present invention relates to laser machining, and more particularly, laser machining systems with an opposite side camera and systems and methods for opposite side alignment, dual side machining, quasi-stealth scribing, and multi-beam stealth scribing.

### BACKGROUND INFORMATION

Various laser machining applications involve alignment of a workpiece with a laser beam that is used to machine the workpiece. Existing laser machining systems include cameras that view an area of the workpiece to be machined to allow the workpiece to be positioned in proper alignment with the laser beam that performs the machining. In some applications, however, the laser beam should be aligned with a feature on an opposite side of a workpiece, i.e., on the side that faces away from the laser beam and the camera used to view the area to be machined by the laser beam.

In semiconductor manufacturing, for example, a laser is often used in the process of dicing a semiconductor wafer such that individual devices (or dies) manufactured from the semiconductor wafer are separated from each other. The dies on the wafer are separated by streets and the laser may be used to cut the wafer along the streets. A laser may be used to cut all the way through the wafer, or part way through the wafer with the remaining portion of the wafer separated by breaking the wafer at the point of perforation. When manufacturing light emitting diodes (LEDs), the individual dies on the wafer correspond to the LEDs.

As the sizes of semiconductor devices decrease, the number of these devices that may be manufactured on a single wafer increases. Greater device density per wafer increases the yield, and similarly reduces the cost of manufacturing per device. In order to increase this density, it is desirable to fabricate these devices as close together as possible.

Positioning the devices more closely on the semiconductor wafer results in narrower streets between the devices. The semiconductor wafer should be aligned with the laser beam such that the cut is positioned precisely within the narrower streets. Thus, alignment techniques are used to provide precise registration of the streets on a semiconductor wafer with a laser, thereby facilitating greater device density per wafer and higher yields. Also, laser machining systems may use air bearing X-Y stages to position the wafers precisely and accurately with the desired alignment.

Laser scribing may be performed on a semiconductor wafer, for example, on the front side of the wafer with the devices formed thereon, referred to as front side scribing (FSS), or on the back side of the wafer, referred to as back side scribing (BSS). In either case (FSS or BSS), the laser beam should be aligned with the streets such that the scribe facilitates separation of the wafer along the streets. Although front side scribing allows a camera to view the streets that face the laser beam and thus facilitates alignment, front side scribing generally requires post processing to remove debris remaining from the scribing process. When the wafer is inverted on the workpiece support for back side scribing such that the streets are facing away from the laser, the debris is kept away from the components on the wafer but the streets are also facing away from the front side camera. In such a position, the front side camera often cannot image the streets sufficiently to provide alignment, particularly when the wafer includes an opaque coating or layer on the back side.

Back side scribing may also present other problems. When back side scribing a wafer with a sapphire substrate, for example, the crystal structure of sapphire causes it to break in preferential cleavage planes (PCP) which are not normal to the GaN film, causing angled cleavage. When the cracks propagate beyond the streets, breakage yields may be reduced. One way to assure crack propagation within the streets when back side scribing is to widen the streets, but this also reduces yield. Another way to prevent the cracks from propagating beyond the streets is to provide deeper scribes, which is slower, requires more energy and may lead to damage from thermal transmission. A more advantageous way to prevent cracks from propagating beyond the streets is to form scribes on both the front side and the back side, referred to as dual side scribing (DSS). When dual side scribing, the scribes on each side of the wafer may be shallower, which results in less heat, damage and debris; but to produce a predictable clean and vertical break, the scribes should be properly aligned to prevent the cracks from propagating beyond the streets.

Accordingly, back side scribing and dual side scribing of semiconductor wafers presents significant alignment challenges because the camera located on the same side as the laser machining process often cannot adequately image a feature on an opposite side. Thus, the registration of the streets with the laser beam may need to be performed from the side opposite the laser machining process. The air bearing X-Y positioning stages used in some existing laser machining systems to provide more accurate and precise positioning, however, prevent the use of a camera on the side of the workpiece opposite the laser machining process.

### BRIEF DESCRIPTION OF THE DRAWINGS

These and other features and advantages will be better understood by reading the following detailed description, taken together with the drawings wherein:

FIGS. 1A and 1B are schematic views of a laser machining system with a workpiece positioning stage in an alignment position and laser machining position, respectively, consistent with an embodiment of the present invention.

FIGS. 2A and 2B are perspective views of one embodiment of an air bearing X-Y positioning stage in an alignment position and a laser machining position, respectively.

FIG. 3 is a side schematic view of back side scribing with opposite side alignment of a laser beam with streets on a semiconductor wafer.

FIGS. 4A-4C are side schematic views of dual side scribing with opposite side alignment of a laser beam with a shallower back side scribe.

FIGS. 5A and 5B are schematic views of a laser machining system with an opposite side camera that moves between an alignment position and a retracted position, respectively.

FIGS. 6A-6C are schematic views of a laser scribing system that shapes and scans a stretched beam across a workpiece, consistent with a further embodiment.

FIG. 7 is a schematic view of a laser scribing system for quasi-stealth scribing, consistent with another embodiment.

FIG. 8 is a schematic view of a laser scribing system for multi-beam stealth scribing, consistent with another embodiment.

### DETAILED DESCRIPTION

A laser machining system, consistent with embodiments of the present invention, may include an opposite side camera to provide workpiece alignment from an opposite side of the system (i.e., the side opposite the laser machining process). The opposite side camera may be used with an air bearing positioning stage that supports a workpiece. A portion of the stage and/or the opposite side camera may be moved to allow the opposite side camera to view and image a feature on the workpiece to be aligned with a laser beam on the opposite side. The laser beam to opposite side alignment may be used with back side scribing and/or dual side scribing of a workpiece with alignment from one or both sides of the workpiece. Laser machining systems and methods, consistent with embodiments of the present invention, may also be used to provide quasi-stealth scribing and multi-beam scribing.

As used herein, “machining” refers to any act of using laser energy to alter a workpiece and “scribing” refers to the act of machining a workpiece while the workpiece is moved linearly relative to the laser. Machining may include, without limitation, laser ablation scribing where the laser energy causes the material of the workpiece to ablate, laser recrystallization scribing where the laser energy causes the material of the workpiece to melt and recrystallize, laser stealth scribing where the laser energy focused internally in the workpiece causes the workpiece to crack internally, and quasi-stealth scribing where the laser energy ablates a portion of the material and is focused into the material through the ablated cut to cause internal fracturing.

Where the workpiece is sapphire, for example, laser ablation scribing may be performed using a 266 nm or 355 nm diode pumped solid state (DPSS) laser or ultrafast laser such that the relatively high photonic energy causes ablation. Laser ablation usually removes material with a pulsed laser, but a continuous wave laser beam may also ablate material if the laser intensity is high enough. Other semiconductor materials, such as GaAs, Si and Ge, may also be scribed using laser ablation.

Laser recrystallization scribing (RCS) of sapphire may be performed using a 355 nm long pulse width laser such that the relatively low photonic energy causes melting and recrystallization. The heat from the laser changes the crystal structure, making it more brittle and breakable at the point of the scribe. Re-crystallization scribing does not physically remove the material at the point of the scribe and thus minimizes debris. The ease of breaking may be dependent upon the width of the crystalline structure, linearity of the scribe in the Z plane and the shape of the scribe.

Laser stealth scribing of sapphire may be performed using a nanosecond IR YAG laser by transmitting the laser energy through the material using a high numerical aperture (NA) lens to achieve high intensity laser energy focused internally for internal material modification. The large bandgap difference of sapphire allows the laser beam to be focused centrally within the sapphire wafer, and the high density dislocation of the crystal structure results in cracking. High peak power causes non linear intensity dependent coupling, and wavelength dependency may be minimized. If the NA lens causes an issue with depth of field, an autofocus system may be used. The stealth scribing technique may not be used with materials having an opaque surface (e.g., a metalized coating on sapphire) because the laser is focused by the high NA lens through the outer surface.

Quasi-stealth laser scribing ablates an outer portion of the material and then focuses the beam internally to cause internal fracturing resulting in scribing or dicing, for example, for wafer die separation. The initial ablation causes a change in index of refraction, which facilitates a waveguide or self focusing effect of the laser into the cut to cause a convergence within the material crystal structure, thereby effectively focusing high electric field energy to a point where crystal damage occurs. Quasi-stealth scribing may be performed, for example, using an ultrafast laser and longer working distance optics (e.g., a lower NA lens as compared to the high NA lenses used for stealth scribing). The laser parameters (e.g., pulse duration, energy density, and wavelength) may be optimized to provide a clean ablation (i.e., with minimal debris) that facilitates the self focusing effect. The ultrafast laser may have a short pulse duration (e.g., picosecond or sub-picosecond) that may be controlled and a wavelength (e.g., infrared, green or UV) that may be selected to provide a nonlinear multiphoton process that facilitates the self-focusing effect within the material. According to another variation of quasi-stealth scribing, an ultrafast laser may be used to provide the first clean cut and then a high intensity laser may be used to internally facture the crystal. The quasi stealth process may be used on materials with opaque coatings because the initial ablation cuts through the opaque coating. The quasi-stealth process may also reduce LED light loss due to less heat and debris and clean LED side walls.

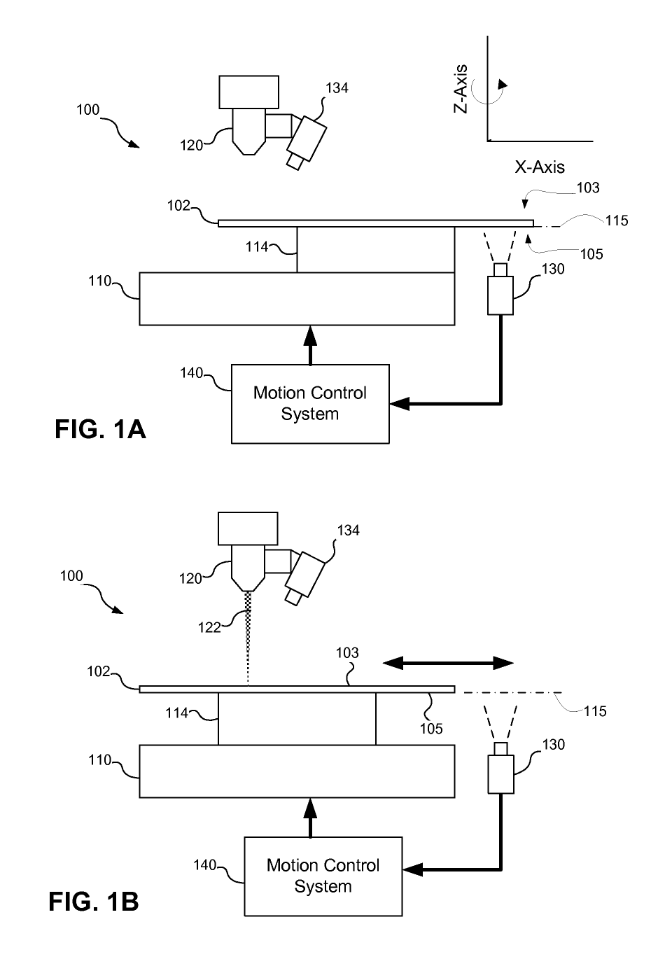

Referring to FIGS. 1A and 1B, a laser machining system 100, consistent with one embodiment, includes an air bearing X-Y positioning stage 110 that supports and positions a workpiece 102. The laser machining system 100 includes a laser beam delivery system 120 mounted on one side (e.g., a top or front side) and an opposite side camera 130 mounted on an opposite side (e.g., a bottom or back side). At least a workpiece supporting portion 114 of the positioning stage 110 is configured to slide between an alignment position (FIG. 1A) with the opposite side camera 130 facing the workpiece 102 and a machining position (FIG. 1B) with the laser beam delivery system 120 facing the workpiece 102. The laser beam delivery system 120 is above a plane 115 of a workpiece support surface on the supporting portion 114 and the opposite side camera 130 is below the plane 115 of the workpiece support surface on the supporting portion 114.

In the alignment position, the opposite side camera 130 images a feature on a side 105 of the workpiece 102 facing the camera 130 and generates image data representing that feature. The image data generated by the opposite side camera 130 may be used to position the workpiece 102 such that the laser beam delivery system 120 is aligned relative to the feature imaged on the opposite side 105 of the workpiece 102, for example, using machine vision systems and alignment techniques known to those skilled in the art. In the machining position, the laser beam delivery system 120 directs a laser beam 122 toward a side 103 of the workpiece 102 facing the beam delivery system 120 and machines the workpiece 102. The laser beam 122 may be used, for example, to scribe the workpiece 102 using scribing techniques known to those skilled in the art.

The laser machining system 100 also includes a motion control system 140 that controls the motion of the positioning stage 110 during alignment and/or machining of the workpiece 102. The motion control system 140 may generate alignment data from the image data generated by the opposite side camera 130 and controls the motion of the positioning stage 110 in response to the alignment data.

The laser beam delivery system 120 may include lenses and other optical elements that modify and shape a raw laser beam generated by a laser, such as a DPSS laser. The laser (not shown) may be located, for example, on a platform of the laser machining system 100 and the raw laser beam generated by the laser may be directed into the laser beam delivery system 120. One example of a laser beam delivery system 120 that may be used is a beam delivery system that shapes a raw laser beam into a line beam that provides an elongated beam spot with a relatively small width, as described in greater detail in U.S. Pat. No. 7,388,172, which is fully incorporated herein by reference.

The laser machining system 100 may also include a front side camera 134 to image the workpiece 102 on the front side. The front side camera 134 may be mounted to the beam delivery system 120 or other suitable location. The front side camera 134 may similarly be coupled to the motion control system 140 such that the motion control system 140 may use the image data generated from the front side camera 134 to provide alignment. The laser machining system 100 may thus allow alignment from the back side opposite the laser beam or from the front side or same side as the laser beam. The opposite side camera 130 and front side camera 134 may be high resolution cameras known to those skilled in the art for alignment of semiconductor wafers in laser machining applications.

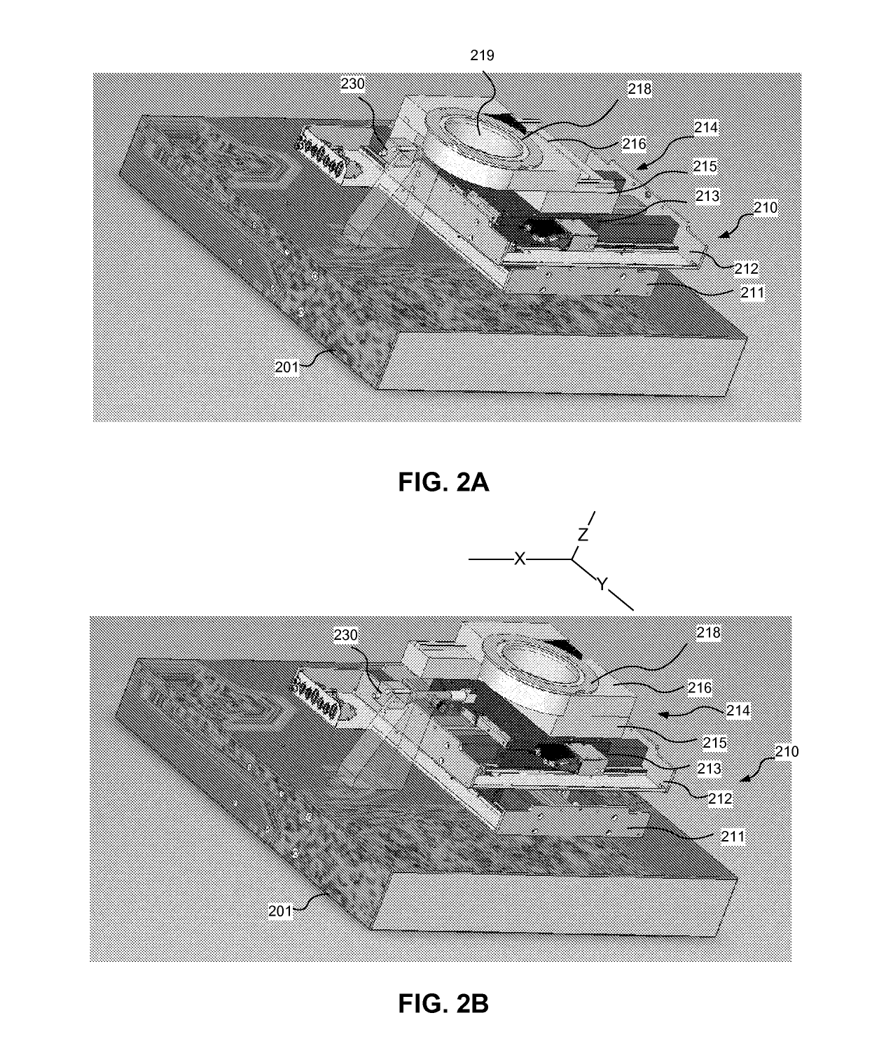

According to one embodiment shown in greater detail in FIGS. 2A and 2B, an air bearing X-Y positioning stage 210 has a workpiece support stage, such as a theta stage 214, slidably mounted thereon such that the theta stage 214 moves between the alignment position (FIG. 2A) and the machining position (FIG. 2B). An opposite side camera 230 is mounted such that a workpiece (not shown) supported on the theta stage 214 is positioned over the opposite side camera 230 in the alignment position. When the theta stage 214 is moved to the machining position, the workpiece supported on the theta stage 214 is positioned under a laser beam delivery system (not shown).

The opposite side camera 230 may be mounted on a laser machining system platform 201 and facing upward such that the camera 230 has visual access to a workpiece mounted on the theta stage 214 in the alignment position. The system platform 201 may be of relatively high mass (e.g., a granite platform) to resist vibration as equipment mounted on the platform 201 is moved. The camera 230 may also be located in a well within the base platform 201 or mounted in other locations in a manner known to those skilled in the art.

The air bearing X-Y positioning stage 210 may include an X-Y stage base 211 mounted on the system platform 201, a first carriage 212 that moves linearly on the X-Y stage base 211 in a first direction (e.g., along the Y axis), and a second carriage 213 that moves linearly on the first carriage 212 in a second direction perpendicular to the first direction (e.g., along the X axis). The carriages 212, 213 may be moved by linear motion devices such as linear motors or servomotors with ball or lead screws. The air bearing X-Y positioning stage 210 may also include position feedback systems such as linear or rotary encoders to provide position feedback to a motion control system. The air bearing X-Y positioning stage 210 may be based on air bearing X-Y positioning stages known to those skilled in the art.

The theta stage 214 may include a theta stage base 215 mounted on the second carriage 213 of the X-Y positioning stage 210 and a theta stage carriage 216 that moves linearly on the theta stage base 215. The theta stage carriage 216 may also be capable of rotating (e.g., the theta axis). The theta stage carriage 216 includes a workpiece support 218 for holding a workpiece and supporting the workpiece. One embodiment of the workpiece support 218 may be a transparent vacuum chuck configured to support a semiconductor wafer and may have an open aperture 219 defined by a ring bearing to provide stability. The theta stage 214 may also be a Z theta stage that provides motion along the Z axis.

The theta stage 214 may include a linear motion device (not shown) that causes the theta stage carriage 216 to move linearly between the alignment and machining positions. In one embodiment, the linear motion device may include air, electric or hydraulic actuators that cause the theta stage carriage 216 to slide on bearings between precision hard stops, such as damped stops. In another embodiment, the linear motion device may include a motorized actuation device such as a servomotor and ball or lead screw or a linear motor.

According to one application, the laser machining systems described herein may be used to machine semiconductor wafers, for example, to manufacture light emitting diodes (LEDs). In such applications, a laser machining system may be used to scribe the semiconductor wafers to separate the dies forming the LEDs. The use of an elongated beam spot with a narrow width and high accuracy air bearing stages allows smaller street widths on the semiconductor wafer, thereby providing higher LED counts.

According to one example of the operation of the illustrated embodiment, a semiconductor wafer (not shown) with streets formed between LED dies may be positioned on the workpiece support 218 with the streets facing downward (e.g., toward the base 201) and oriented with the streets substantially parallel to the X axis. To provide alignment according to this embodiment, the theta stage carriage 216 may be moved to the alignment position (FIG. 2A) and the first carriage 212 may be moved in the Y direction while imaging at least one of the streets with the opposite side camera 230 until the street is substantially aligned (i.e., along the Y axis) relative to a location where a laser will impact the wafer on the other side of the wafer. The theta stage carriage 216 may then be moved to the machining position (FIG. 2B) while maintaining the aligned position along the Y axis. The second carriage 213 may then be moved in the X direction to form scribe on a side of the wafer opposite the aligned street. The first carriage 212 may be moved in the Y direction to index to another street for scribing. The alignment process may be repeated as need for other streets.

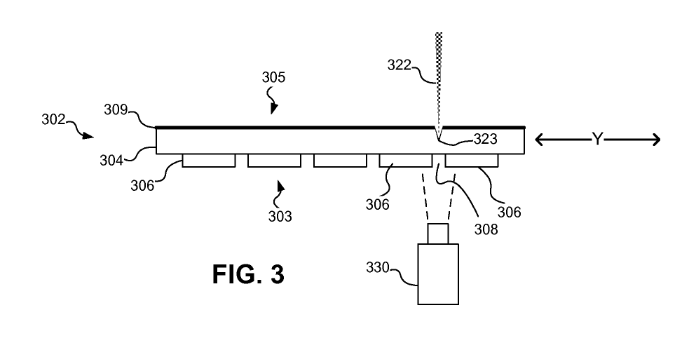

Referring to FIG. 3, opposite side alignment may be used to facilitate back side scribing of a semiconductor wafer 302 to separate a plurality of semiconductor dies (e.g., LEDs). The semiconductor wafer 302 may include a substrate 304 (e.g., sapphire) and one or more layers of semiconductor material (e.g., GaN) formed into sections 306 separated by streets 308. The side of the semiconductor wafer 302 with the sections 306 is referred to as the front side 303 and the opposite side is referred to as the back side 305. The substrate 304 may also have one or more layers 309 (e.g., metal) on the back side 305 opposite the sections 306.

A laser machining system, such as those described above, may be used to scribe the semiconductor wafer 302 along the streets 308 between the die sections 306 to separate the semiconductor wafer 302 into individual dies. The semiconductor wafer 302 is thus aligned such that a laser beam 322 is directed at the semiconductor wafer 302 between the streets 308, thereby providing registration of the die sections 306 with the laser beam 322.

When laser machining the back side 305 of the semiconductor wafer 302, the semiconductor wafer 302 may be positioned such that the die sections 306 on the front side 303 of the wafer 302 face the opposite side camera 330. The opposite side camera 330 may thus be used to view the streets 308 between the sections 306 and to provide alignment of the streets 308 relative to a location of the laser beam 322. Alignment using the opposite side camera 330 is particularly advantageous when the back side layer(s) 309 are opaque (e.g., metal) and prevent alignment from the machining side. To provide such alignment, the wafer 302 is positioned along the Y axis relative to the laser beam delivery system (not shown) such that a scribe 323 formed by the laser beam 322 on the back side 305 of the wafer 302 is located within the width of the street 308 on the front side 303.

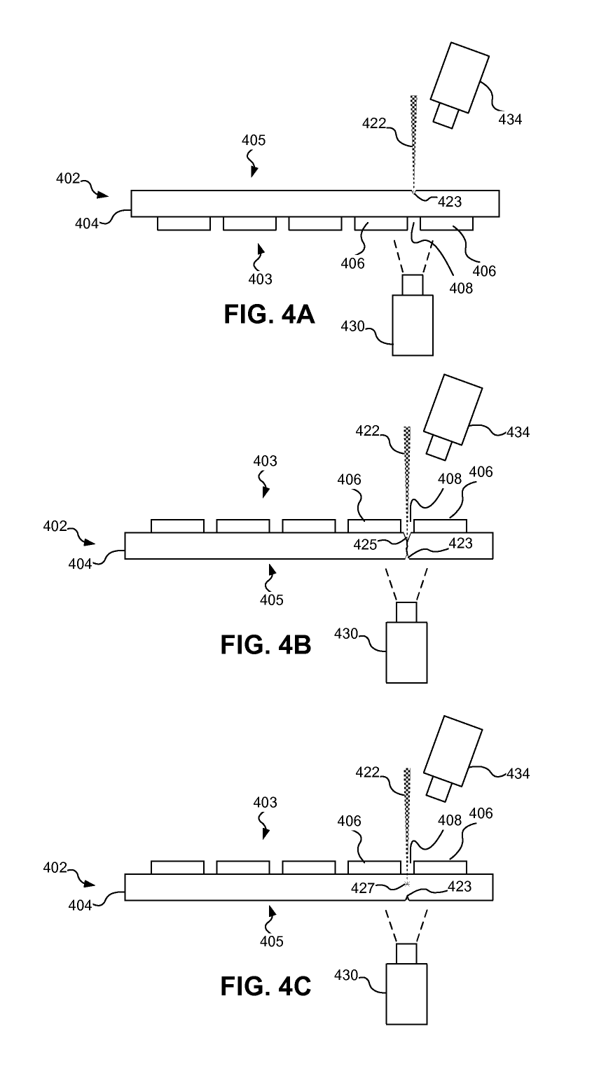

Referring to FIGS. 4A and 4B, opposite side alignment may be used to facilitate dual side scribing. In general, dual side scribing involves forming relatively shallow scribes on both sides of a workpiece with one of the scribes substantially aligned relative to the other of the scribes. Forming shallow scribes minimizes or avoids damage that may be caused by deeper scribes while having scribes on both sides may improve breaking yields because cracks are more likely to propagate between the scribes.

According to one exemplary method, a semiconductor wafer 402 may first be positioned (e.g., on the workpiece support) with a back side 405 facing a laser beam delivery system (not shown) and a front side 403 facing an opposite side camera 430 (FIG. 4A). With the wafer 402 in this position, the opposite side camera 430 may be used to image one of the streets 408 between the sections 406 so that the wafer 408 can be positioned such that the laser beam 422 on the back side 405 is aligned with the street 408 on the front side 403. When the semiconductor wafer 402 has been aligned, the laser beam 422 may be used to scribe the back side 405 forming a relatively shallow back side scribe 423 (e.g., 20 microns or less).

The semiconductor wafer 402 may then be flipped such that the front side 403 faces the laser beam delivery system and the back side 405 faces the opposite side camera 430 (FIG. 4B). With the wafer 402 in this position, the opposite side camera 430 may be used to image the back side scribe 423 so that the wafer 402 can be positioned such that the laser beam 422 is aligned with the back side scribe 423. When the semiconductor wafer 402 has been aligned, the laser beam 422 may be used to scribe the front side 403 in the street 408 between the sections 406 to form a front side scribe 425 substantially aligned with the back side scribe 423. In addition to or instead of the opposite side camera 430 providing alignment, a machining side camera 434 may image the street 408 to provide alignment of the laser beam 422 with the street 408.

The wafer 402 may then be separated into individual dies by breaking along the locations of the scribes 423, 425 such that cracks propagate between the scribes 423, 425. When the sections 406 correspond to LEDs, for example, the front side scribe 425 better defines the edge of the LED such that the LED is more uniform and breakage yields are improved (e.g., as compared to shallow scribes on one side only). Furthermore, the LED light and electrical properties are less likely to be adversely affected because the scribes 423, 425 are not deep enough to cause significant thermal damage.

According to another alternative method, the front side scribe 425 may be formed first on the front side 403 (e.g., using the machining side camera 434 to provide alignment relative to the streets 408). The wafer 402 may then be flipped and the back side scribe 423 may be formed on the back side 405 (e.g., using the opposite side camera 430 to provide alignment relative to the front side scribe 425 and/or streets 408). One of the scribes may be shallower than the other scribe. For example, the shallower scribe (e.g., 20 microns or less) may be formed first with the second, less shallow scribe being aligned with the shallower scribe.

Another variation of a dual side scribing method is shown in FIG. 4C. According to this method, a first shallow back side scribe 423 may be formed by ablation on the back side 405 of the wafer 402, as shown in FIG. 4A. A second front side scribe 427 may then be formed from the front side 403 of the wafer 402 by focusing the laser beam 422 internally within the substrate 404 of the wafer 402 and creating internal crystal damage (e.g. stealth or quasi-stealth scribing). The back side shallow scribe 423 may be used to create a crystal defect, which allows the second internal front side scribe 427 to be formed with less intensity and better internal crystal defect locations as compared to conventional stealth scribing techniques.

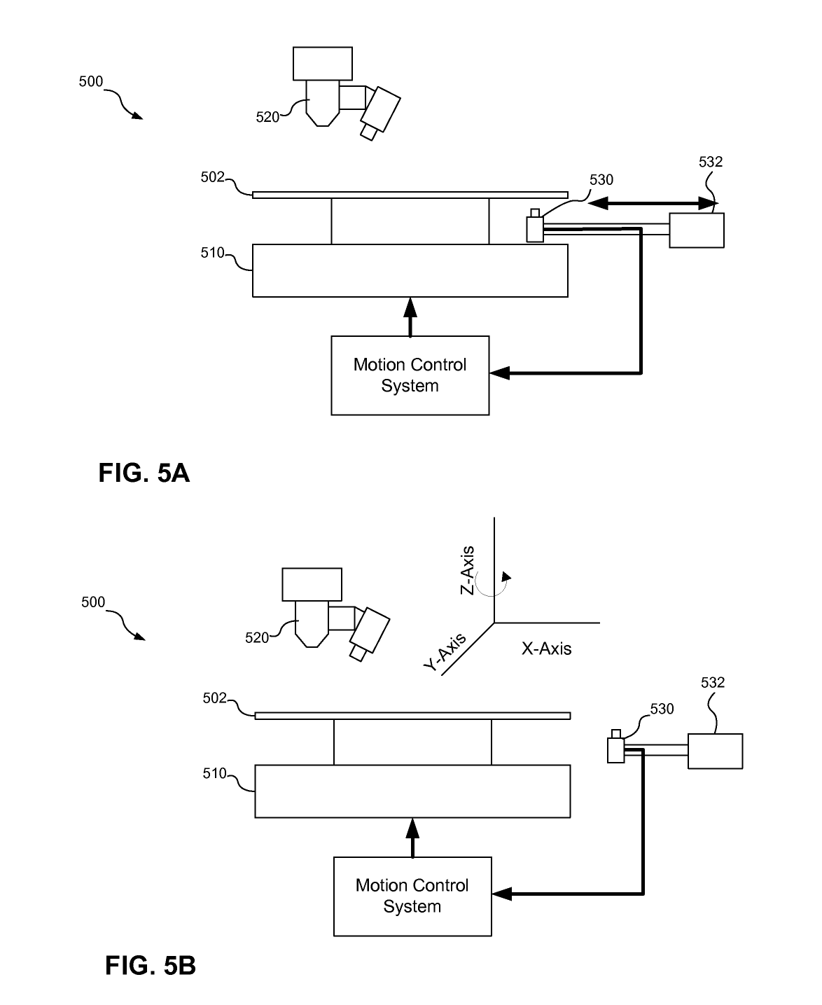

According to another embodiment shown in FIGS. 5A and 5B, a laser machining system 500 may include an opposite side camera 530 that slides between an alignment position (FIG. 5A) and a retracted position (FIG. 5B). Similar to the embodiment described above, the laser machining system 500 includes an air bearing X-Y positioning stage 510 supporting a workpiece 502 with the opposite side camera 530 being located below a plane of the workpiece support surface. In the alignment position, the opposite side camera 530 is directed at a side of the workpiece 502 that faces away from a laser beam delivery system 520. The opposite side camera 530 is coupled to a linear motion device 532 that moves the camera 530 linearly. The camera linear motion device 532 may be similar to the linear motion device used for the theta stage carriage described above.

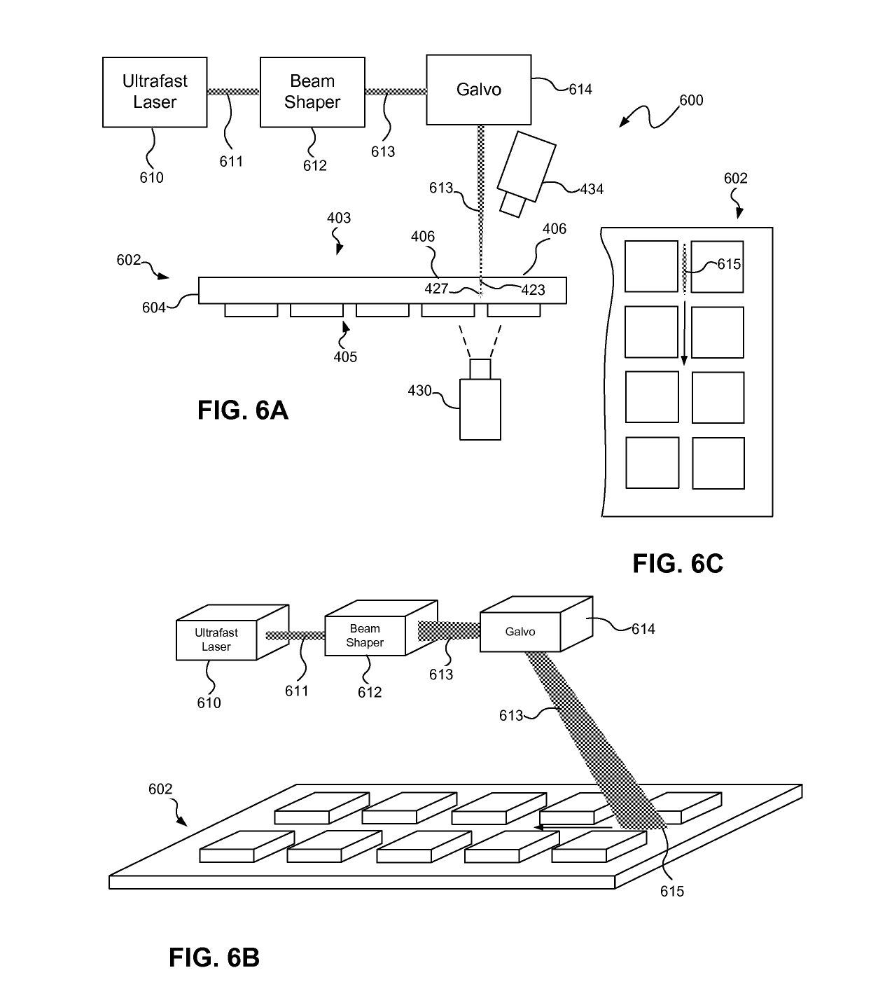

Referring to FIGS. 6A-6C, one embodiment of a scribing system 600 and method that may be used for back side or dual side scribing is described in greater detail. This embodiment of the scribing system 600 includes an ultrafast laser 610 for generating a raw laser beam 611, a beam shaper 612 for shaping the raw laser beam 611 to produce a shaped beam 613, and a galvanometer 614 for scanning a shaped beam spot 615 along a workpiece 602 to perform the scribing.

The ultrafast laser 610 is generally a laser capable of emitting ultrashort pulses, i.e., pulses with durations of femtoseconds or picoseconds. The ultrafast laser 610 may be capable of producing the raw laser beam 611 at different wavelengths (e.g., about 0.35 μm, 0.5 μm or 1 μm or any increments therebetween) and at different ultrashort pulse durations (e.g., less than about 10 ps). Using a longer wavelength and a much shorter pulse (e.g., as compared to a 266 nm DPSS laser) allows better coupling efficiency and absorption of the laser energy particularly in highly transparent materials such as sapphire. The ultrafast laser 610 thus improves the ability to perform back side scribing of a workpiece 602 with a substrate 604 made of sapphire or some other highly transparent material. One example of an ultrafast laser is a Trumicro series 5000 picosecond laser available from TRUMPF.

According to one method, the pulse duration may be shorter than the thermal diffusion timescale causing rapid vaporization of the material, i.e., evaporative ablation with a direct solid to vapor transition. To minimize melting, for example, the pulse duration may be sub-picosecond. The wavelength and pulse duration of the raw laser beam 611 may also be varied to control absorption of the laser energy in the workpiece 602 being scribed. The wavelength and pulse duration may be set to provide an absorption of laser energy that results in disturbing the crystalline structure of the substrate, for example, to perform stealth scribing or quasi-stealth scribing.

The beam shaper 612 includes a beam delivery system with beam shaping optics capable of stretching the raw beam 611 and forming the beam spot 615 with an elongated shape. In one embodiment, the beam shaper 612 includes beam shaping optics capable of forming a variable astigmatic focal beam spot, for example, as described in greater detail in U.S. Pat. No. 7,388,172, which is fully incorporated herein by reference. Such a beam shaper 612 is capable of controlling the energy density of the variable astigmatic focal beam spot as the length of the spot is varied. The beam shaper 612 may include, for example, an anamorphic lens system including a cylindrical plano-concave lens and a cylindrical plano-convex lens and varying a distance between these lenses varies the length of the beam spot and the energy density on the workpiece.

The beam shaper 612 may thus be used to vary the energy density of the beam spot 615 on the workpiece 602 to optimize the fluence and coupling efficiency for a particular material or scribing operation. When performing dual side scribing on a GaN coated sapphire substrate, for example, the energy density of the beam spot 615 may be adjusted higher to optimize scribing of the bare sapphire (i.e., back side scribing) and may be adjusted lower to optimize scribing of the GaN coated sapphire (i.e., front side scribing). In other words, one side of the workpiece may be scribed with the laser beam spot optimized for that side, the workpiece may be flipped, and the other side may be scribed with the laser beam spot optimized for that side. The beam shaper 612 thus avoids having to adjust the laser power to change the energy density and optimize the fluence.

The galvanometer 614 may be a 1-D or 2-D galvanometer known to those skilled in the art for scanning a laser beam. The galvanometer 614 may scan the beam spot 615 across the workpiece 602 instead of or in addition to moving the workpiece 602 using the X-Y positioning stage. Using the galvanometer 614 to scan the beam spot 615 increases speed at which the beam spot 615 may be moved across the workpiece 602 and thus increases the scribing speeds. Although the illustrated embodiment shows the galvanometer 614 for scanning the beam spot 615, the ultrafast laser 610 and beam shaper 612 may also be used without a galvanometer 614 (e.g., with a motion stage to moved the workpiece in the scan direction).

Accordingly, the laser machining systems described herein allow use of an opposite side camera to provide opposite side alignment with the stiffer, more stable air bearing stages, which otherwise make it more difficult to access the side of the workpiece opposite the laser machining process. These stiffer, more stable air bearing stages are generally more precise and accurate than open frame stages that make it easier to access the opposite side of the workpiece.

The opposite side alignment and dual side scribing techniques disclosed herein also allow shallower cuts removing less material, thereby minimizing debris and increasing throughput without significantly reducing yields. The opposite side alignment and dual side scribing techniques also facilitate the use of thick wafers. A thicker wafer is less prone to breakage during handling and processing and bows and warps less, further enabling faster scribing and narrower streets, thus resulting in more die per wafer. Although thicker wafers are more difficult to break, dual side scribing on both sides of the thicker wafers may facilitate breakage.

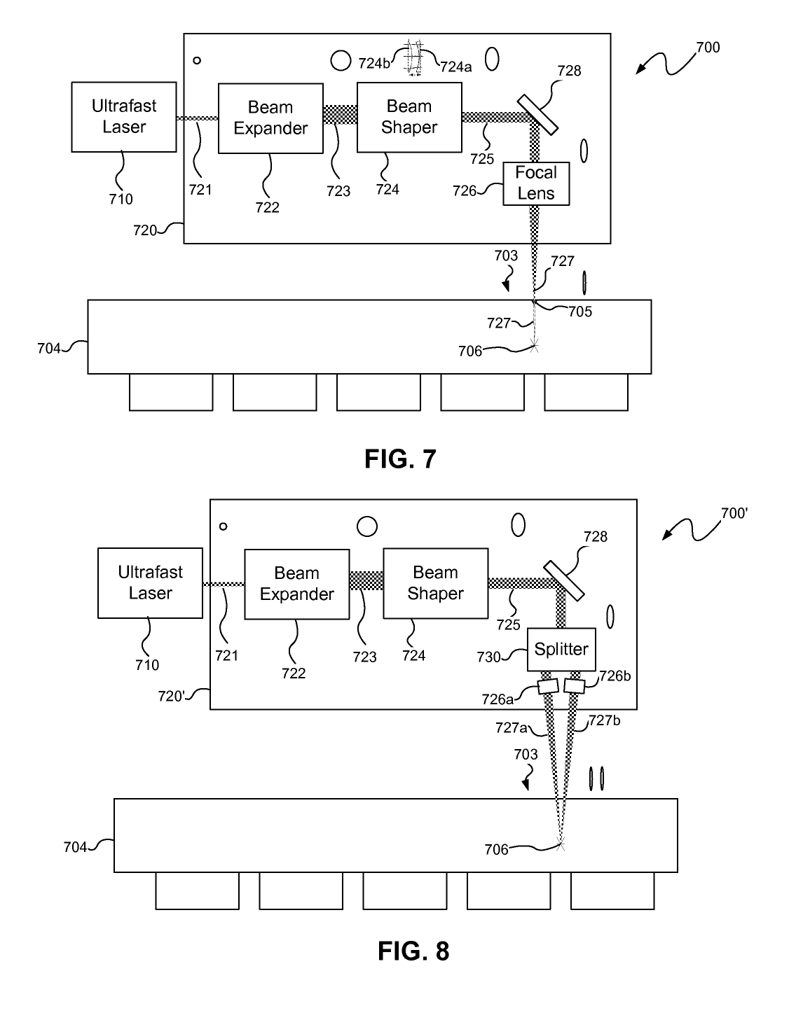

Referring to FIG. 7, one embodiment of a laser machining system 700 for quasi-stealth scribing a workpiece 704, such as a sapphire substrate of a semiconductor wafer, is described in greater detail. As mentioned previously, quasi-stealth scribing involves laser ablating material on the surface 703 of the workpiece 704 in an ablation zone 705 and using a waveguide or self-focusing effect to direct the laser beam from the ablation zone 705 to an internal location 706 within the workpiece 704 where crystal damage is caused due to shock, electric fields and/or pressure. Although the exemplary embodiment refers to a sapphire substrate and operating parameters for quasi-stealth scribing a sapphire substrate, the same techniques can be used to machine other substrates or materials that are at least partially transparent and capable of allowing a laser beam to pass at least partially through the material.

The laser machining system 700 for quasi-stealth scribing may include an ultrafast laser 710 capable of emitting ultrashort pulses (e.g., less than 1 ns) at a wavelength capable of passing at least partially through the material and a beam delivery system 720 capable of providing a well-focused line beam. One embodiment of the beam delivery system 720 includes a beam expander 722 for expanding the raw laser beam 721 from the ultrafast laser 710 to form an expanded beam 723, a beam shaper 724 for shaping the expanded beam 723 to form an elliptical shaped beam 725, and a focusing lens 726 for focusing the elliptical shaped beam 725 to provide a well-focused line beam 727 that forms a line beam spot on and/or within the workpiece 704. The beam delivery system 720 may also include one or more reflectors 728 to reflect and redirect the laser beam as needed.

In particular, the beam delivery system 720 may include beam shaping optics capable of forming a variable elongated astigmatic focal beam spot, for example, as described in greater detail in U.S. Pat. No. 7,388,172, which is fully incorporated herein by reference. The elongated astigmatic focal beam spot has a length in the astigmatic axis that is longer than a width in the focused axis. Such a beam delivery system is capable of controlling the energy density of the variable astigmatic focal beam spot as the length of the spot is varied. The beam shaper 724 may include, for example, an anamorphic lens system including a cylindrical plano-concave lens 724a and a cylindrical plano-convex lens 724b such that varying a distance between these lenses varies the length of the beam spot and the energy density on the workpiece.

In other embodiments, a nonlinear optical crystal, such as BBO crystal or beta-BaB₂O₄, may be used as a beam shaper. BBO crystals are known for use with a laser as a frequency-doubling crystal. Because the BBO crystal provides more walk-off than other crystals (e.g., CLBO), a substantially circular beam entering the crystal may become an elliptical beam upon exiting the crystal. Although the walk-off may not be desirable in many applications, this characteristic of the BBO crystal provides a unique advantage in an application where an elliptical shaped beam is desired.

The combination of the well-focused line beam with the ultrashort pulses allows an increased focusability (with lower NA optics) to provide the crystal damage at the internal location 706 of the workpiece 704 while minimizing the volume of removed material (e.g., the debris) on the surface 703 of the workpiece. The ultrafast laser 710 and the beam delivery system 720 may be configured with laser machining parameters, such as wavelength, pulse duration, pulse energy, peak power, repetition rate, scan speed, and beam length and width, that achieve the surface ablation and self-focusing effect for the material to be scribed and the desired kerf widths.

According to one embodiment of a laser machining system 700 for quasi-stealth scribing sapphire, the ultrafast laser 710 may emit a beam at a wavelength of about 343 nm with a pulse duration of less than about 10 ps and a pulse energy of about 60 μJ. Such a laser provides a wavelength capable of passing through sapphire and a sufficiently high peak power to damage the crystal at the internal location within the sapphire. In one example, the ultrafast laser 710 may be one of the TruMicro series 5000 picosecond lasers available from TRUMPF. The ultrafast laser 710 may be operated at a repetition rate to achieve a desired scribe at a particular scan speed. According to one example of machining sapphire, the 343 nm laser with a pulse energy of about 60 μJ may be operated with a repetition rate of about 33.3 kHz and a scan speed in a range of about 70 mm/s to 90 mm/s. In another example, the repetition rate may be about 100 kHz with a scan speed of about 100 mm/s to 300 mm/s.

According to the exemplary embodiment for quasi-stealth scribing sapphire, the beam expander 722 may be a 2× expanding telescope and the focusing lens 716 may be a 60 mm triplet to achieve an effective focusability with a focal beam length of about 400 μm and a desired kerf width of about 3 μm. The beam expander 722 may be a beam expanding telescope, for example, including a combined uncoated negative lens (e.g., f=−100 mm) and a positive lens (e.g., f=200 mm).

Although one example is described that is capable of quasi-stealth scribing sapphire, other laser machining parameters are possible for both sapphire and other materials. A lower power laser (e.g., about 8 W) may be used, for example, with a reduced beam length and pulse energy (e.g., about 40 μJ) and a higher repetition rate (e.g., about 200 kHz). Depending upon the materials being scribed, the laser wavelength may also be in the infrared (IR) range as well as the first through fifth harmonics and more particularly in a range of about, for example, 1.04-1.06 μm (IR), 514-532 nm (green), 342-355 nm (UV), or 261-266 nm (UV).

The exemplary embodiment of the laser machining system 700 may be used for both front side (epi) scribing and back side (sapphire) scribing on a semiconductor wafer with LED dies. The laser machining system 700 may further modify the beam to improve the quality of the scribe depending upon the application. To avoid epi layer delamination issues in certain applications (e.g., back side scribing), for example, the laser machining system 700 may provide spatial filtering at the edges of the beam to clean up the point spread function in the narrow direction of the beam. In another embodiment, the focusing lens 726 may include higher NA optics (e.g., >˜0.8) to achieve a well defined internal focus and avoid having the beam leak or pass beyond the internal location to cause damage on the opposite side of the workpiece.

In yet another embodiment, the line shaped beam may be split into two or more lower NA beamlets and crossed over internally within the workpiece to achieve the desired high power capable of damaging the crystal at the internal location, thereby performing multi-beam stealth scribing. According to one embodiment of a beam delivery system 720′ used for multi-beam stealth scribing, shown in FIG. 8, a beam splitter 730 splits the elliptical shaped beam 725 into elliptical shaped beamlets 727a, 727b and multiple focusing lenses 726a, 726b focus the individual line shaped beamlets 727a, 727b on the workpiece 704 such that the beamlets cross over or intersect at the internal location 706 within the workpiece 704. The focusing lenses 726a, 726b may be longer focus or lower NA lenses (e.g., as compared to conventional stealth scribing). Although two beamlets are shown, multi-beam stealth scribing techniques may also split the beam into more than two beamlets.

Accordingly, the quasi-stealth and multi-beam stealth scribing techniques described herein may be capable of scribing a workpiece, such as a sapphire substrate of a semiconductor wafer, with minimal or significantly reduced heat and debris. By reducing or minimizing the heat and debris generated, LEDs may be produced with low electrical damage and light loss and without requiring additional coating and cleaning processes.

Consistent with one embodiment, a laser machining system includes a base platform, at least one air bearing X-Y positioning stage mounted on the platform base, and at least one workpiece support stage mounted on the air bearing X-Y positioning stage. The workpiece support stage includes a workpiece support surface configured to support a workpiece. The workpiece support stage is configured to slide linearly from a machining position to an alignment position. The laser machining system also includes at least one laser beam delivery system for directing at least one laser beam. The laser beam delivery system is mounted above a plane of the workpiece support surface such that the laser beam is directed to a side of a workpiece supported on the workpiece support stage when the theta stage is located in the machining position. The laser machining system further includes at least one opposite side camera for generating image data. The opposite side camera is mounted below the plane of the workpiece support surface on the workpiece support stage such that the opposite side camera is directed toward the side of the workpiece that faces away from the laser beam delivery system when the workpiece support stage supporting the workpiece is located in the alignment position. A motion control system is coupled to the opposite side camera and the X-Y positioning stage, for generating alignment data from the image data and for controlling motion of the stage in response to the alignment data.

Consistent with another embodiment, a method of laser scribing includes: mounting a workpiece on a workpiece support surface of a support stage, wherein a laser beam delivery system is located above a plane of the workpiece and an opposite side camera is located below a plane of the workpiece, wherein the support stage is mounted on an air bearing X-Y positioning stage; moving at least one of the support stage and the opposite side camera relative to each other such that the opposite side camera is directed at a bottom side of the workpiece facing away from the laser beam delivery system; imaging a feature on the bottom side of the workpiece with the opposite side camera to generate image data; processing the image data to generate alignment data representing a location of the feature on the bottom relative to an alignment location of the laser beam delivery system; positioning the air bearing X-Y positioning stage based on the alignment data to move the workpiece such that the laser beam delivery system is aligned with the workpiece relative to the feature on the bottom side of the workpiece; and machining the workpiece with a laser from the laser beam delivery system.

Consistent with a further embodiment, method is provided for laser scribing a semiconductor wafer including an array of dies on a front side with streets formed between the dies. The method includes: positioning the semiconductor wafer with a back side facing a laser beam delivery system; aligning the semiconductor wafer such that a laser beam delivery system will deliver a laser beam to the back side with the laser beam being located within a width of one of the streets on the front side of the semiconductor wafer; scribing the back side of the wafer with the laser beam to form at least one back side scribe; positioning the semiconductor wafer with the front side facing the laser beam delivery system; aligning the semiconductor wafer such that a laser beam delivery system will deliver a laser beam to the front side with the laser beam being located within a width of one of the streets on the front side of the semiconductor wafer and substantially aligned with the at least one back side scribe; and scribing the front side of the wafer with the laser beam to form at least one front side scribe.

Consistent with yet another embodiment, a method is provided for dual side laser scribing a workpiece. The method includes: positioning the workpiece with a first side facing a laser beam delivery system; adjusting the laser beam delivery system to produce a laser beam spot having a first energy density at the workpiece; scribing the first side of the wafer with the laser beam spot to form at least one first side scribe; positioning the workpiece with a second side facing the laser beam delivery system; adjusting the laser beam delivery system to produce a laser beam spot having a second energy density at the workpiece; aligning the workpiece such that the laser beam spot is substantially aligned with the at least one first side scribe; and scribing the second side of the workpiece with the laser beam spot to form at least one second side scribe.

Consistent with yet another embodiment, a method is provided for quasi-stealth scribing a workpiece. The method includes: generating a raw laser beam with ultrashort pulses having a pulse duration of less than 1 ns; expanding the raw laser beam to form an expanded beam; shaping the expanded beam to form an elliptical shaped beam; and focusing the elliptical shaped beam on the workpiece to form a line shaped beam spot such that an energy density of the line shaped beam spot is sufficient to ablate a surface of the substrate at an ablation zone and the elliptical shaped beam passes through the ablation zone to an internal location within the workpiece to cause crystal damage to the workpiece at the internal location.

Consistent with yet a further embodiment, a method is provided for multi-beam stealth scribing a workpiece. The method includes: generating a raw laser beam with ultrashort pulses having a pulse duration of less than 1 ns; forming the raw laser beam into a plurality of elliptical shaped beamlets; and focusing the plurality of elliptical shaped beamlets on the workpiece to form a plurality of line shaped beamlets that cross over at an internal location within the workpiece and cause crystal damage to the workpiece at the internal location.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A laser machining system comprising:
a base platform;
at least one air bearing X-Y positioning stage mounted on the platform base;
at least one workpiece support stage mounted on the air bearing X-Y positioning stage, the workpiece support stage including a workpiece support surface configured to support a workpiece, wherein the workpiece support stage is configured to slide linearly from a machining position to an alignment position;
at least one laser beam delivery system for directing at least one laser beam, wherein the laser beam delivery system is mounted above a plane of the workpiece support surface such that the laser beam is directed to a side of a workpiece supported on the workpiece support stage when the theta stage is located in the machining position; and
at least one opposite side camera for generating image data, wherein the opposite side camera is mounted below the plane of the workpiece support surface on the workpiece support stage such that the opposite side camera is directed toward the side of the workpiece that faces away from the laser beam delivery system when the workpiece support stage supporting the workpiece is located in the alignment position; and
a motion control system coupled to the opposite side camera and the X-Y positioning stage, for generating alignment data from the image data and for controlling motion of the stage in response to the alignment data.

2. The laser machining system of claim 1 further comprising at least one machining side camera for generating image data from a side of the workpiece that faces the laser beam delivery system, wherein the machining side camera is mounted above a plane of the workpiece support surface on the workpiece support stage such that the machining side camera is directed toward the side of the workpiece that faces the laser beam delivery system when the workpiece support stage supporting the workpiece is located in the machining position.

3. The laser machining system of claim 1 wherein the workpiece support stage includes a transparent vacuum chuck providing the workpiece support surface.

4. The laser machining system of claim 1 wherein the laser beam delivery system is configured to receive a raw laser beam generated by a laser and to form an elongated astigmatic beam spot on the workpiece.

5. The laser machining system of claim 4 wherein the laser is located on the platform base.

6. The laser machining system of claim 4 wherein the laser beam delivery system includes a beam shaper for shaping the raw laser beam.

7. The laser machining system of claim 6 wherein the beam shaper is configured to shape the raw laser beam into an elongated astigmatic focal beam spot and is configured to adjust a length and energy density of the elongated astigmatic focal beam spot.

8. The laser machining system of claim 6 wherein the laser beam delivery system includes a galvanometer for receiving the shaped laser beam and for scanning the shaped laser beam across the workpiece.

9. The laser machining system of claim 4 wherein the laser is an ultrafast laser capable of generating ultrashort laser pulses.

10. A method of laser scribing comprising:
mounting a workpiece on a workpiece support surface of a support stage, wherein a laser beam delivery system is located above a plane of the workpiece and an opposite side camera is located below a plane of the workpiece, wherein the support stage is mounted on an air bearing X-Y positioning stage;
moving at least one of the support stage and the opposite side camera relative to each other such that the opposite side camera is directed at a bottom side of the workpiece facing away from the laser beam delivery system;
imaging a feature on the bottom side of the workpiece with the opposite side camera to generate image data;
processing the image data to generate alignment data representing a location of the feature on the bottom relative to an alignment location of the laser beam delivery system;
positioning the air bearing X-Y positioning stage based on the alignment data to move the workpiece such that the laser beam delivery system is aligned with the workpiece relative to the feature on the bottom side of the workpiece; and
machining the workpiece with a laser from the laser beam delivery system.

11. The method of claim 10 wherein moving the support stage and the opposite side camera relative to each other includes sliding the support stage linearly from a machining position to an alignment position.

12. The method of claim 10 wherein moving the support stage and the opposite side camera relative to each other includes sliding the opposite side camera linearly from a retracted position to an alignment position.

13. The method of claim 10 wherein the workpiece is a semiconductor wafer including an array of dies on a front side with streets formed between the dies, wherein the semiconductor wafer is mounted on the workpiece support with the front side facing down, wherein the feature imaged by the opposite side camera is one of the streets, and wherein machining the workpiece includes scribing the semiconductor wafer on a back side opposite the dies such that the scribe is aligned between the streets on the opposite side.

14. The method of claim 10 wherein the workpiece is a semiconductor wafer, wherein the semiconductor wafer is mounted on the workpiece support with a first side facing down, wherein the feature imaged by the opposite side camera is a scribe on the first side, and wherein machining the workpiece includes scribing the semiconductor wafer on a second side opposite the first side such that the scribe on the second side is aligned with the scribe on the first side.

15. The method of claim 14 wherein the semiconductor wafer includes an array of dies on a front side with streets formed between the dies.

16. The method of claim 15 wherein the front side is the first side, wherein the scribe on the first side is located in the streets between the dies, and wherein scribing the semiconductor wafer on the second side includes scribing the back side such that the scribe on the back side is aligned with the scribe in the streets on the opposite front side.

17. The method of claim 15 wherein the back side is the first side, wherein the scribe on the first side is opposite the streets between the dies on the front side, and wherein scribing the semiconductor wafer on the second side includes scribing the front side between the streets such that the scribe on the front side is aligned with the scribe on the opposite back side.

18. The method of claim 10 wherein machining the workpiece includes scribing a first side of the workpiece with a laser from the laser beam delivery system to form a first scribe, flipping the workpiece, and scribing a second side of the workpiece with a laser from the laser beam delivery system to form a second scribe aligned with the first scribe.

19. A method of laser scribing a semiconductor wafer including an array of dies on a front side with streets formed between the dies, the method comprising:
positioning the semiconductor wafer with a back side facing a laser beam delivery system;
aligning the semiconductor wafer such that a laser beam delivery system will deliver a laser beam to the back side with the laser beam being located within a width of one of the streets on the front side of the semiconductor wafer;
scribing the back side of the wafer with the laser beam to form at least one back side scribe;
positioning the semiconductor wafer with the front side facing the laser beam delivery system;
aligning the semiconductor wafer such that a laser beam delivery system will deliver a laser beam to the front side with the laser beam being located within a width of one of the streets on the front side of the semiconductor wafer and substantially aligned with the at least one back side scribe; and
scribing the front side of the wafer with the laser beam to form at least one front side scribe.

20. The method of claim 19 wherein one of the front side and back side scribes is formed using ablation.

21. The method of claim 19 wherein one of the front side and back side scribes is formed using re-crystallization scribing.

22. The method of claim 19 wherein one of the front side and back side scribes is formed using quasi-stealth scribing.

23. The method of claim 19 wherein one of the front side and back side scribes is formed using ablation and one of the front side and back side scribes is formed using re-crystallization scribing.

24. The method of claim 19 wherein one of the front side and back side scribes is formed using ablation and one of the front side and back side scribes is formed using quasi-stealth scribing.

25. A method of dual side laser scribing a workpiece, the method comprising:
positioning the workpiece with a first side facing a laser beam delivery system;
adjusting the laser beam delivery system to produce a laser beam spot having a first energy density at the workpiece;
scribing the first side of the wafer with the laser beam spot to form at least one first side scribe;
positioning the workpiece with a second side facing the laser beam delivery system;
adjusting the laser beam delivery system to produce a laser beam spot having a second energy density at the workpiece;
aligning the workpiece such that the laser beam spot is substantially aligned with the at least one first side scribe; and
scribing the second side of the workpiece with the laser beam spot to form at least one second side scribe.

26. The method of claim 25 wherein the workpiece is a GaN coated sapphire substrate.

27. The method of claim 25 wherein the laser beam spot is formed by an ultrashort pulse laser beam generated by an ultrafast laser.

28. The method of claim 27 wherein the ultrashort pulse laser beam has a pulse width less than 10 picoseconds.

29. The method of claim 27 wherein the ultrashort pulse laser beam has a wavelength in a range of about 0.35 μm to 1 μm.

30. The method of claim 25 wherein the laser beam spot is a variable astigmatic focal beam spot, and wherein the laser beam delivery system is adjusted to adjust a length and energy density of the variable astigmatic focal beam spot.

31. The method of claim 25 wherein scribing the first side or the second side of the workpiece includes scanning the laser beam spot across the workpiece.

32. A method of quasi-stealth laser scribing a workpiece, the method comprising:
generating a raw laser beam with ultrashort pulses having a pulse duration of less than 1 ns;
expanding the raw laser beam to form an expanded beam;
shaping the expanded beam to form an elliptical shaped beam; and
focusing the elliptical shaped beam on the workpiece to form a line shaped beam spot such that an energy density of the line shaped beam spot is sufficient to ablate a surface of the substrate at an ablation zone and the elliptical shaped beam passes through the ablation zone to an internal location within the workpiece to cause crystal damage to the workpiece at the internal location.

33. The method of claim 32 wherein the pulse duration is less than about 10 ps.

34. The method of claim 32 wherein the laser wavelength is 343 nm and the pulse duration is less than about 10 ps.

35. The method of claim 32 wherein the raw laser beam is shaped by an anamorphic lens system including a cylindrical plano-concave lens and a cylindrical plano-convex lens.

36. The method of claim 32 wherein the raw laser beam is shaped by a BBO crystal.

37. The method of claim 32 wherein the raw laser beam is expanded by a 2× beam expanding telescope.

38. The method of claim 37 wherein the elliptical shaped beam is focused by a lens triplet.

39. The method of claim 32 wherein the workpiece is a semiconductor wafer including a sapphire substrate.

40. A method of multi-beam stealth laser scribing a workpiece, the method comprising:
generating a raw laser beam with ultrashort pulses having a pulse duration of less than 1 ns;
forming the raw laser beam into a plurality of elliptical shaped beamlets; and
focusing the plurality of elliptical shaped beamlets on the workpiece to form a plurality of line shaped beamlets that cross over at an internal location within the workpiece and cause crystal damage to the workpiece at the internal location.

41. The method of claim 40 wherein forming the raw laser beam into a plurality of elliptical shaped beamlets comprises:
shaping the raw laser beam with an anamorphic lens system including a cylindrical plano-concave lens and a cylindrical plano-convex lens to form an elliptical shaped beam; and
splitting the elliptical shaped beam to form the plurality of elliptical shaped beamlets.

42. The method of claim 40 wherein the pulse duration is less than about 10 ps.
